(19) United States
(12) Patent Application Publication
(10) Pub. No.: US 2025/0111352 A1
(43) Pub. Date: Apr. 3, 2025

(54) Indoor Location-Based Payment System

(71) Applicant: Toshiba Global Commerce Solutions, Inc., Durham, NC (US)

(72) Inventors: David John Steiner, Durham, NC (US); Craig Lynn Compton, Wake Forest, NC (US); Daniel Joseph Hunt, Wake Forest, NC (US)

(21) Appl. No.: 18/477,837

(22) Filed: Sep. 29, 2023

(51) Int. Cl. G06Q 20/32; G06Q 20/42; H04N 5/265

(52) U.S. Cl. CPC G06Q 20/3224; G06Q 20/327; G06Q 20/42; H04N 5/265

(57) ABSTRACT

A point-of-sale system is provided. The point of sale system receives map data that includes a plurality of dining locations in a dining environment, collects image information captured by a mobile device of a user in which the image information includes an image associated with a dining location of the user within the dining environment, determines the dining location of the user based on the collected image information and the map data, and transmits, to the mobile device, payment information for the dining location of the user. A payment method is also provided.

### BACKGROUND

Providing options for customers to pay their restaurant bill at a table adds convenience to the dining experience. Traditionally, a restaurant employee brings a printed check to the table for customers to review and pay. Customers may pay via cash, credit card or digital payment forms. Additional ways for customers to pay include using QR codes or near field communication (“NFC”) readers. QR codes may be provided at the table or on a printed check. Customers scan with the QR code with their smart phones to complete the payment process. Customers can also use their smart phones to pay using a point-of-sale NFC reader.

### BRIEF DESCRIPTION OF THE SEVERAL VIEWS OF THE DRAWINGS

The present disclosure will be explained with reference to the following figures in which:

FIG. 1 illustrates an embodiment of an environment in accordance with some embodiments of the present disclosure.

FIG. 2 is a diagram illustrating point-of-sale system in accordance with some embodiments of the present disclosure.

FIGS. 3A and 3B are plan views of seating maps including a plurality of dining locations within an indoor restaurant or dining establishment in accordance with some embodiments of the present disclosure.

FIGS. 4A and 4B are diagrams illustrating a payment application on a mobile device in accordance with some embodiments of the present disclosure.

FIG. 5 is a flow diagram illustrating a routine in accordance with some embodiments of the present disclosure.

FIG. 6 is a flow diagram illustrating a method in accordance with some embodiments of the present disclosure.

FIG. 7 is a basic block diagram of a data processor that can be used to process data provided through the point-of-sale system in accordance with some embodiments of the present disclosure.

### DETAILED DESCRIPTION

Exemplary embodiments of the present disclosure are described in detail with reference to the accompanying drawings. The disclosure may, however, be exemplified in many different forms and should not be construed as being limited to the specific exemplary embodiments set forth herein. Rather, these exemplary embodiments are provided so that this disclosure will be thorough and complete, and will fully convey the scope of the disclosure to those skilled in the art.

When patrons are dining out at restaurants, they often wait for a server or restaurant employee to bring a payment statement (e.g., a check) to the table after dining is complete in order to begin the payment process. Such statements are often brought to the dining table in a payment folder and the patron may place cash or a credit card in the payment folder. The restaurant employee retrieves the payment folder to facilitate the payment transaction for payment processing and returns the payment folder with the patron's credit card or surplus cash to the patron at the table. During this process, patrons may experience delays, either in the initial delivery of the payment statement or in the completion of the payment transaction.

In addition to traditional payment statement methods, Quick Response (QR) codes and Near Field Communication (NFC) readers may be employed to accelerate the payment process for patrons. QR codes can redirect patrons to a designated web page or function within a specialized dining establishment application to display the pending payment statement and propose various methods for transaction completion. Furthermore, the incorporation of NFC readers into the dining environment can help patrons accelerate the payment process by bringing NFC-enabled devices, like smartphones or payment cards, into close proximity to the reader, thus streamlining both the initiation and finalization of transactions. However, the visual impact of QR codes and NFC readers can be less than ideal for upscale dining venues, and the requisite hardware and software for these technologies can contribute to incremental operational expenditures.

In accordance with the present inventive concept, an indoor location-based interaction system is provided, thereby enabling patrons to access and pay their payment statements through their mobile device while remaining at their dining tables.

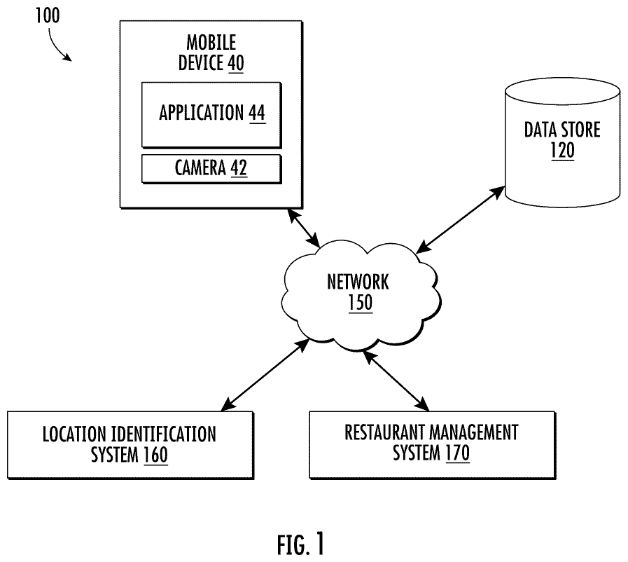

FIG. 1 illustrates an embodiment of an environment 100 that includes a network 150, a mobile device 40, a data store 120, a location identification system 160, and a restaurant management system 170. To simplify discussion and not to limit the present disclosure, FIG. 1 illustrates only one mobile device 40, data store 120, location identification system 160, and restaurant management system 170, though multiple may be used.

Any of the foregoing components or systems of the environment 100 may communicate via the network 150. Although only one network 150 is illustrated, multiple distinct and/or distributed networks may exist. The network 150 can include any type of communication network. For example, the network 150 can include one or more of a wide area network (WAN), a local area network (LAN), a cellular network (e.g., LTE, HSPA, 3G, and other cellular technologies), an ad hoc network, a satellite network, a wired network, a wireless network, and so forth. In some embodiments, the network. 150 can include the Internet.

Any of the foregoing components or systems of the environment 100, such as any one or any combination of the mobile device 40, the data store 120, the location identification system 160, or the restaurant management system 170, may be implemented using individual computing devices, processors, distributed processing systems, servers, isolated execution environments (e.g., virtual machines, containers, etc.), shared computing resources, or so on. Furthermore, any of the foregoing components or systems of the environment 100 may be combined and/or may include software, firmware, hardware, or any combination(s) of software, firmware, or hardware suitable for the purposes described.

The mobile device 40 may execute an application 44, which can be a specialized dining establishment application designed to facilitate point-of-sale transactions. For example, the application 44 may provide an interface through which a user can view their dining check and pay their dining check, thereby streamlining the payment process and enhancing the overall dining experience.

The application 44 may include a web browser, a mobile application or “app,” a background process that performs various operations with or without direct interaction from a user, or a “plug-in” or “extension” to another application, such as a web browser plug-in or extension. Although FIG. 1 illustrates the application 44 as being implemented on the mobile device 40, it will be understood that any of the components or systems of the environment 100 may host, execute, or interact with the application 44. Furthermore, in some cases, the application 44 may be hosted or executed by one or more host devices (not shown), which may broadly include any number of computers, virtual machine instances, and/or data centers that are configured to host or execute one or more instances of the application 44.

The mobile device 40 represents any computing device capable of interacting with or running the client application 44. Examples of client devices 40 may include, without limitation, smart phones, tablet computers, handheld computers, wearable devices, laptop computers, desktop computers, servers, portable media players, gaming devices, and so forth.

Through the employment of the mobile device 40 and/or the application 44, diners are afforded the capability to engage directly in a range of dining-related functions, including but not limited to, the selection of menu offerings, the review of accumulated dining charges, or the facilitation of payment transactions. These functions can be accomplished without necessitating the diner's departure from their designated seating location, thereby augmenting the overall dining experience while simultaneously enhancing operational efficiency within the restaurant or food service establishment.

The mobile device 40 can include a camera 42, which can be employed to facilitate indoor-location-based technologies such as VPS. By capturing image data through the camera 42, the location identification system 160 can analyze the data in conjunction with stored map data and restaurant data. This analysis can assist in virtually associating the user's mobile device 40 with a specific dining table within the restaurant, to which a check is also assigned. Consequently, the payment application hosted on the mobile device 40 can facilitate the retrieval and payment of the check corresponding to the user's dining table. The inclusion of camera 42 in the mobile device 40 for indoor VPS applications further enhances functionality and accuracy, benefitting not only payment transactions but also offering other restaurant-based utilities such as personalized service, targeted promotions, and enhanced customer experience.

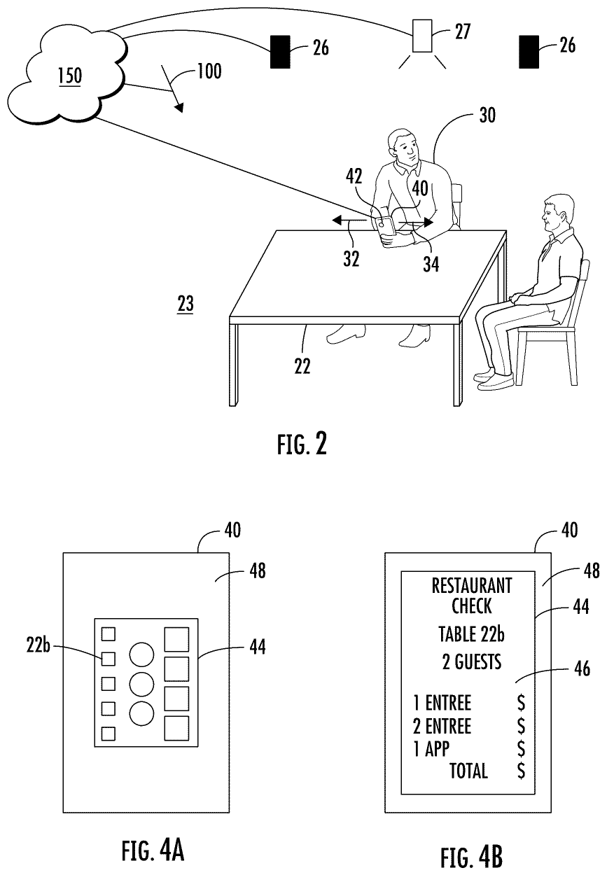

The data store 120 can be used to manage data within the environment 100. In some cases, the data store 120 can manage or store location data, map data, image data and or restaurant data. Map data may include seating layouts (e.g., provided by the restaurant), such as seating map 20, or indications of visual elements like signage locations, windows, artwork or emergency exits. Map data may also include data provided by a camera 27 in a dining area 23 (FIG. 2) as further described below. Location data may include, but is not limited to, the geographic location (e.g., GPS coordinates) of diners, dining tables, or service areas like the kitchen or restrooms within the restaurant. The image data may include, for example, visual representations such as images of the dining area, individual dining tables, table settings, and the surrounding ambiance, facilitating the identification of tables based on visual cues. Restaurant data may include table numbers assigned to each table, a list of available menu items, pricing information, order information, and/or client/diner information. For example, the restaurant data may assign each dining table a table number, the table number from the restaurant data may then be used in conjunction with the map data, location data and image data to determine which table a user is seated at. The restaurant data can also include an itemized list of menu items ordered by the diners at the table.

The data store 120 can include associations between various types of data, such as location data, image data, and map data, to enable more accurate and efficient system operations. For example, when a user captures photographs of the environment using their mobile device, this captured image data can be analyzed in conjunction with stored map data and restaurant data to determine the table at which the user is seated. This integrated approach leverages multiple data sources to accurately pinpoint the user's location within the restaurant, thereby facilitating activities such as mobile payments and personalized services.

The data store 120 can include or be implemented as cloud storage, such as Amazon Simple Storage Service (S3), Elastic Block Storage (EBS) or CloudWatch, Google Cloud Storage, Microsoft Azure Storage, InfluxDB, etc. The data store 120 can be made up of one or more data stores storing data that has been received from one or more of the mobile device 40, the application 44, the location identification system 160, or the restaurant management system 170. The data store 120 can be configured to provide high availability, highly resilient, low loss data storage.

The location identification system 160 can be employed to establish an association between a user and a dining table within an eating establishment. The location identification system 160 can analyze image data, acquired from camera 42 within mobile device 40, in correlation with map data and restaurant data retained in data store 120. Based on the analysis, the location identification system 160 can determine the dining table at which the user is situated. Following this determination, the location identification system 160 can interact with the application 44, facilitating the assignment of the identified table to the user accessing the application 44 on their mobile device 40. Subsequently, the application 44 can enable access to a dining check associated with that particular table, thereby offering a pathway for the user to finalize payment via mobile device 40.

The location identification system 160 receives location data, map data, image data and or restaurant data from restaurant management system 170, data store 120, mobile device 40 and/or network 150 and processes the data to obtain results. Referring now to FIGS. 1 to 3B, for example, the location identification system 160 receives map data from data store 120 showing a seating map 20 for a configuration 24 of dining tables 22 in a dining area 23. The seating map 20 may include video or image data and is further described below. The location identification system 160 also collects image data from camera 42 of mobile device 40 from user 30. The location identification system 160 then determines which dining table the user 30 is seated at in the dining area 23 based on the image information collected from camera 42 and the map data provided, e.g., the location identification system 160 can determine a user is seated at table number 22b based on the image information and map data. The location identification system 160 is able to request and/or retrieve payment information associated with table 22b and transmit this payment information to the mobile device 40 of the user 30 seated at table 22b. The user can then pay the dining check via their mobile device 40, for example.

The location identification system 160 can determine the location of the user and/or the specific table at which the user is seated in a restaurant through various techniques. These techniques can include indoor location technologies such as wireless signal triangulation, beacons emitting Bluetooth signals, Visual Positioning System (VPS), and inertial sensors, among others. For example, wireless signals may facilitate meter-level accuracy by measuring the time taken for a signal to travel between two wireless devices. Beacons can emit signals that interact with the mobile device to ascertain location within a constrained environment. VPS can leverage computer vision and machine learning algorithms to analyze captured images and compare them with a pre-mapped database of images to determine position. Additionally, inertial sensors and magnetic fields can be utilized to further refine the location determination process. These multiple approaches can be used either independently or in combination to establish the user's location, enabling the location identification system 160 to interact with application 44 and assign the identified table to the user for transactional purposes.

Indoor location technology locates devices inside venues, including the position, orientation, floor and building. Since GPS does not work indoors, indoor location technology relies on other signals and techniques to provide an indoor location including, for example, wireless signals, Bluetooth iBeacons, inertial sensors, magnetic fields, etc.

Wireless signals now include advanced capabilities that can bring location determination indoors to meet growing market demand for mobile location-based services. Wireless signals are able to bring the same user experience indoors as is expected from outdoor location-based services, such as GPS. Wireless signals may deliver meter-level accuracy for indoor device location data. By leveraging the ubiquity of wireless networks, wireless location delivers position data without the need to deploy a separate network infrastructure. Wireless location supports indoor navigation and asset tracking and other located based services without the sacrifices associated with indoor use.

Wireless location delivers accuracy by determining the distance between two wireless devices, such as an access point and a smartphone, by measuring the time taken for a wireless signal to travel from one device to the other. Previously, devices typically determined indoor location by measuring signal strength which has limited accuracy, or fingerprinting which is more difficult to maintain. Meter-level accuracy enabled with wireless location brings new levels of precision to indoor location.

Beacons may also be used to provide indoor location. Beacons are small, easy-to-install devices without any connectivity that emit a signal that can be used to locate a mobile device inside a building. Beacons may be used due to operating system restrictions that may not automatically detect wireless signals. In at least one example, a “beacon” may be any suitable hardware component that communicates with a mobile device to facilitate a transaction. The hardware may be similar to the technology used in location tags, for example, Apple AirTags® and generate a Bluetooth® signal.

Visual Positioning System (VPS) is a technology that uses computer vision and machine learning algorithms to determine the location and orientation of a device or vehicle in the physical world. VPS works by comparing images captured by a device's camera with a database of pre-mapped images and using machine learning techniques to estimate the device's position and orientation based on the similarities and differences between the captured images and the pre-mapped images. VPS can be used for various applications, including indoor and outdoor navigation, augmented reality, and autonomous vehicle localization. VPS uses signals from several satellites thus helping to overcome inaccuracies. VPS is beneficial in situations where GPS signals are weak or unavailable, such as indoors or in urban canyons. VPS can be used with other positioning technologies, such as GPS, to provide a more accurate and reliable estimate of the device's position and orientation. VPS can also be used as a standalone technology in cases where GPS signals are not needed or unavailable.

Indoor VPS is a technology that uses computer vision and machine learning algorithms to determine the location and orientation of a device or vehicle within an indoor environment. It is similar to traditional GPS but is designed to work in environments where satellite signals are not available or are less accurate, such as within buildings or urban canyons. VPS uses phone cameras and extensive back-end data to analyze the surroundings to identify the location with great accuracy.

Indoor tracking and positioning systems may also be used to track and locate entities inside buildings. Indoor tracking and positioning systems include a network of electronic devices and computer software that is used to locate people or objects where and when GPS lacks precision or fails entirely. While the terms indoor tracking and indoor positioning are interchangeable, there are multiple different types of technology, as well as techniques, currently that may be used to calculate and provide real-time location data. These include radio-based, optical, magnetic and acoustic technologies.

The present disclosure uses indoor location technologies and VPS including wireless signals, Wi-Fi®, Bluetooth®, beacons, inertial sensors, magnetic fields, and ultra-wideband technologies to determine the location of a user within a restaurant in real time in order to complete a transaction. A user accesses a camera on their mobile device so the camera can provide image data to a payment application. Using computer vision technologies, indoor location technologies and VPS the payment application can determine the user's dining table within a restaurant. A check corresponding to the user's dining table can be retrieved and paid via the payment application.

The restaurant management system 170 can send and receive information from the network 150, data store 120 and location identification system 160. The restaurant management system can be used by restaurant management and kitchen staff to determine which tables are seated, which tables are reserved, place orders, and maintain dining tabs and dining checks. The restaurant management system can manage a specialized dining establishment application (e.g., the application 44) that interacts with the mobile device 40. This specialized application can be geared towards enhancing point-of-sale transactions and other customer-focused operations.

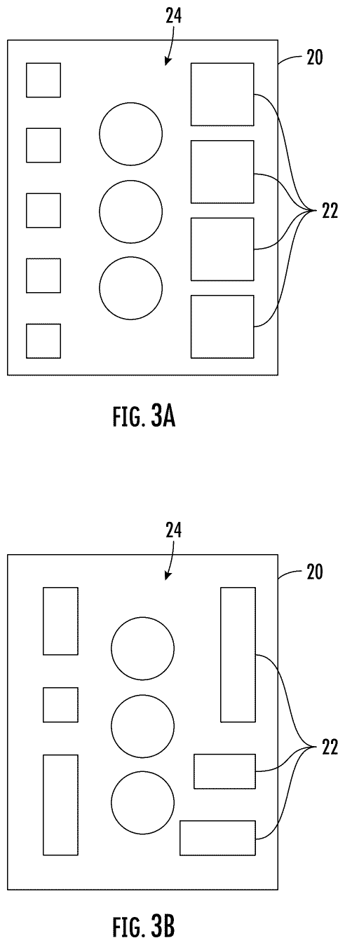

Referring again to FIGS. 1 to 3B, map data, for example, a restaurant map 20 of a dining room 23 including a plurality of dining locations 22 arranged in a desired configuration 24 for a restaurant or dining establishment is shown. Each dining location 22 may represent one dining table. A configuration 24 of dining locations 22 in FIG. 3A includes 12 dining tables whereas a configuration 24 of dining locations 22 in FIG. 3B includes 9 dining tables. The number and size of dining tables 22 in each configuration 24 may vary as desired. In accordance with the present disclosure, restaurant maps 20 may be accessed by a location identification system 160, restaurant management system 170 and/or a payment application 44 for use by diners at a restaurant when the diners want to view or pay their check.

The map data/restaurant maps 20 may be uploaded to network 150, data store 120, restaurant management system 170, and/or payment application 44. The restaurant maps 20 may include videos or images of the dining area 23. The map data/restaurant maps 20 may be in communication with the restaurant management system 170 used by the restaurant for seating and for placing kitchen orders. For example, before the start of evening dinner service, a restaurant employee may use a camera 27 (FIG. 2) to record the dining area as it is configured for the evening's dinner service. Each table may be assigned a number or identifier which is then used as a reference for the table for the location identification system 160, payment application 44 and restaurant management system 170 that manages seating guests and/or placing orders with the kitchen. In at least one embodiment, the payment application 44 is integrated with the location identification system 160 and restaurant management system 170 used to seat guests or place orders in the kitchen.

In at least one embodiment, configuration 24 relied upon by the restaurant may be stored electronically, for example, in data store 120, such that a saved configuration 24 may be selected for use by the location identification system 160 and/or payment application 44. In at least one embodiment, images from a camera 27 feed may be used to update the restaurant map 20 throughout the course of the day or night as needed. The camera 27 may provide images or updates at set time intervals, for example, to capture the configurations for a plurality of set seating times, on demand or as needed.

FIG. 2 illustrates a user seated at a dining table 22. The user 30 has a mobile device 40 that includes a camera 42, display 48 and payment application 44. In accordance with the present disclosure, a user 30 pays his restaurant bill or check 46 by accessing a payment application 44 on his mobile device 40. After completion of a dining event, user 30 initiates point-of-sale system 100 via mobile device 40 by accessing a payment application 44 on their mobile device 40. The payment application 44 prompts the user to open the mobile camera 42 on mobile device 40 and view the area adjacent to user 30 with the camera 42 by, for example, moving the mobile device 40 to the right 32 or left 34 in proximity of the user 30. The user 30 may need to approve the payment application's 44 use of camera 42. The user 30 may remain seated while the user 30 views the adjacent area. The user 30 does not have to use the camera 42 to record the viewed area. In at least one example, the camera 42 viewpoint of the adjacent area is sufficient image information from camera 42. In another example, image information includes: VPS, indoor positioning technology, computer vision, indoor triangulation positioning, Google Street View®, Live View on Google Maps® and other image characteristics, in order to determine a location of user 30 with enough precision to identify which table 22 on restaurant map 20 the user 30 is seated. In at least one embodiment, it may be sufficient for the user 30 to open the camera 42, the user 30 may not need to move the mobile device 40 to the right 32 or left 34. In at least one embodiment, the user 30 may move the mobile device 40 slightly to the right 32 or left 34.

The camera 42 can capture a range of image information types to facilitate precise location identification within the restaurant environment. This spectrum of image data can include, but is not limited to, patterns of table settings, distinguishable architectural features, color schemes, lighting conditions, decorative elements, and signage. Moreover, the system can be capable of recognizing unique markers or fiducial tags placed within the environment to assist in localization. These markers can be QR codes, barcodes, or other machine-readable identifiers. Additionally, the system may incorporate advanced technologies such as depth sensing to evaluate the three-dimensional spatial characteristics of the environment.

To process this set of image information, the location identification system 160 can employ a variety of image segmentation and analysis techniques. The system can execute object recognition algorithms to differentiate between different types of tables, chairs, and other furnishings. Edge detection algorithms can be utilized to delineate the boundaries between different architectural elements or between objects and the background. Color segmentation can be used to distinguish areas based on hue, saturation, and brightness values, which can be particularly beneficial when identifying uniquely colored zones or areas within the restaurant. Furthermore, the system may employ machine learning models trained on similar restaurant environments to optimize the identification process.

In specific embodiments, technologies such as Visual Positioning System (VPS), indoor positioning technology, computer vision, and indoor triangulation positioning can be integrated with the captured image data to enhance location determination. Services like Google Street View® and Live View on Google Maps® can be used to cross-reference the captured image information with existing databases. This multi-layered approach can ensure a robust and reliable location identification, enabling the system to effectively interact with the payment application 44 and assign the correctly identified table to the user 30 for the completion of point-of-sale transactions.

As explained above, indoor location-based technology can locate a user's position within one meter of accuracy and visual positioning systems such as camera-based location can enhance this accuracy such that the dining location 22 of a user 30 in a dining room 23 can be determined. Using the mobile camera 42 enhances the indoor location-based technology via visual positioning system technology and computer vision and allows the payment application 44 to determine accurately which dining location 22 the user 30 is seated.

The mobile device 40 is an electronic device having at least a wireless communication means, geographic location sensing means, data processing capability, and data input/output capability. An example of a suitable mobile device is the Apple IPHONE® smart phone, although there are many others in existence. The mobile device 40 and camera 27 may be connected to a network 150.

Referring now to FIGS. 1, 2, 4A and 4B, once the location identification system 160 determines that a user 30 is seated at dining table 22b by using image information and map data provided by camera 42 and restaurant map 20 in addition to indoor location technology, VPS and/or computer vision. Upon detection of the dining location 22b, the payment application 44 provides the user 30 with a dining check 46 associated with the dining location 22b by displaying the dining check 46 on the user's mobile device 40. The dining check 46 may be retrieved through communication with location identification system 160 and/or restaurant management system 170 used to place kitchen orders, for example. At this time, the user 30 can review and pay the dining check 46. The user 30 may pay for the check 46 via the payment application 44 or another payment method via the mobile device 40 such as mobile wallet or cash if desired. Mobile wallets may include, for example, Apple Pay®, Samsung Pay®, Google Pay®, WeChatPay® and WePay®.

In at least one embodiment, beacons 26 may be provided at the restaurant. Beacons 26 may be used together with indoor location technology, VPS and computer vision to aid in determining the dining location 22b. Beacons may also be connected to network 150.

Restaurant maps 20 are accessible by location identification system 160, restaurant management system 170 and/or the payment application 44. Restaurant maps 20 may be updated in real-time. For example, a restaurant employee may update the restaurant map 20 as dining tables are arranged, rearranged, and seated to accommodate varying sized dining parties. In at least one embodiment, the restaurant maps 20 are in communication with the restaurant management system 170 used to place orders with the kitchen in real-time such that the map includes the dining check information as the meal or dining experience transpires in real-time. Thus, users may be able to view their dining check midway through the meal if desired. In at least one embodiment, when a user initiates the payment system 100, a server or restaurant employee is alerted and encouraged to review or finalize the diner's check. In at least one embodiment, a user is able to use the payment application 44 and mobile camera 42 to locate their table, retrieve their check and pay their check without any assistance from a restaurant employee.

By using indoor location technology enhanced with visual positioning system technology, restaurants can provide customers with options to retrieve, review and pay their bills without requiring additional infrastructure or hardware at each table or restaurant location.

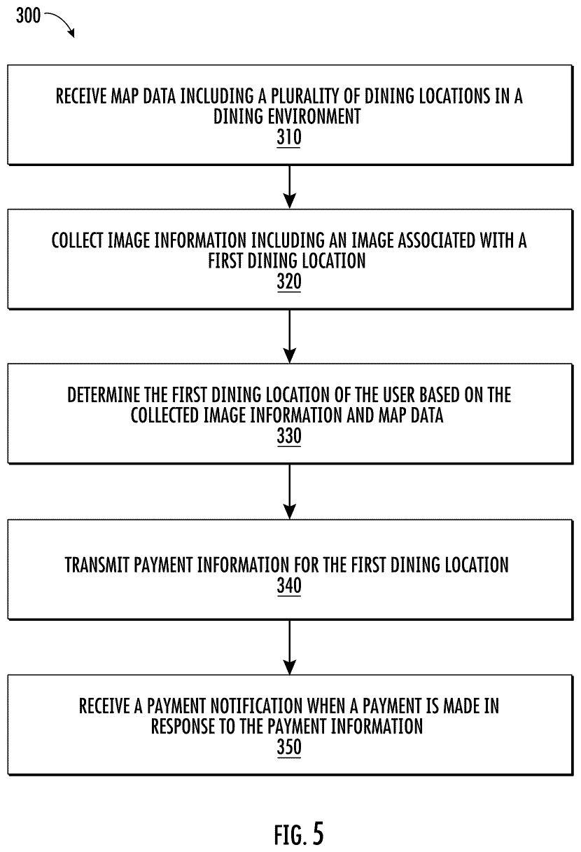

FIG. 5 is a flow diagram illustrative of an embodiment of a routine 300 implemented by a computing device of the environment 100. Although described as being implemented by the location identification system 160, it will be understood that the elements outlined for routine 300 can be implemented by one or more computing devices/components that are associated with the environment 100, such as, but not limited to, the mobile device 40, the client application 44, the data store 120, or the restaurant management system 170, etc. Thus, the following illustrative embodiment should not be construed as limiting. Furthermore, fewer, more, or different blocks can be used as part of the routine 300.

At block 310, the location identification system 160 obtains map data from the data store 120. This map data may include seating layouts, geographical layouts of the restaurant, or other relevant architectural details. The map data may also include auxiliary details, such as locations of visual elements like signage, emergency exits, or service areas like kitchens or restrooms. The map data can be formatted in multiple ways, such as vectors, image data, or other geometric or non-geometric forms. With reference to FIGS. 2 to 3B, the map data may include, for example, a seating map 20 having a configuration 24 of a plurality of dining tables 22 in a dining area 23 of a restaurant. The map data may include image information and video information.

In some cases, the location identification system 160 can be configured to update this map data periodically or upon triggering certain events. Events that trigger an update can include but are not limited to modifications in the restaurant layout, introduction of new dining tables, or renovations affecting the dining environment. This ensures that the location identification system 160 operates based on the most recent and relevant map data, thereby improving the accuracy of its operations. With reference to FIG. 2, camera 27 may provide map data continuously and/or intermittently.

At block 320, the location identification system 160 collects image information corresponding to data captured by a camera 42 of the mobile device 40. The image information may include one or more still images, video frames, or other visual data relevant to identifying a user's dining location. In some cases, the location identification system 160 can initiate the collection upon receiving an explicit user request via the application 44 or upon detecting pre-configured conditions, such as the mobile device entering a geofenced area around the restaurant.

The collected image information can be forwarded to a processing unit within the location identification system 160 for further analysis. The image information can be processed using various algorithms and techniques, including but not limited to computer vision algorithms, object detection, and image segmentation, to isolate features relevant for identifying the dining location of the user within the dining environment.

For example, consider a scenario where a user has completed their meal and is ready to request the bill. The user can take out their mobile device 40, launch the application 44, and use the camera 42 to scan their surroundings within the dining environment. This action triggers the location identification system 160 to collect the relevant image information, which may include a series of still images or video frames capturing various elements of the dining location, such as the layout, table configuration, and any distinct visual markers within the area.

At block 330, the location identification system 160 determines a dining location of the user based on the collected image information and the obtained map data. The location identification system 160 can make this determination by cross-referencing the extracted features from the image information with the map data. The use of multiple data types, such as seating layouts or visual element locations from the map data, can be considered to enhance the precision of the location determination.

The determined dining location can be marked by identifiers, such as table numbers or similar designations, and this identifier can be stored temporarily or permanently in the data store 120 for subsequent use. Once the dining location is determined, the location identification system 160 can be programmed to perform other actions, such as facilitating the assignment of this determined location to the user profile, enabling streamlined mobile payments and other personalized services.

At block 340, the location identification system 160 transmits payment information corresponding to the determined dining location to the mobile device 40. The payment information may include an itemized bill, tax calculations, suggested tip percentages, and options for payment methods, among other details. The transmission can be encrypted to ensure security and privacy and can be conducted over one or more networks, such as LAN, WAN, or cellular networks.

In some cases, the application 44 is a specialized dining establishment application that already incorporates elements of bill payment. In some such cases, the location identification system 160 can serve as a complementary feature, enabling the automated determination of the user's dining table using image data. When a user accesses the application 44 on their mobile device 40, the location identification system 160 can assign the corresponding table number based on the determined dining location. This streamlined interaction simplifies the user experience, eliminating the need for manual input of table numbers and ensuring that the correct bill is associated with the user's session.

After transmitting the payment information, the location identification system 160 can be programmed to receive a confirmation of payment completion from the mobile device 40. Upon receiving this confirmation, additional actions can be performed by the location identification system 160. For instance, a receipt can be sent to the mobile device 40, and the status of the dining table in the restaurant management system 170 can be updated to indicate that it is available for future patrons.

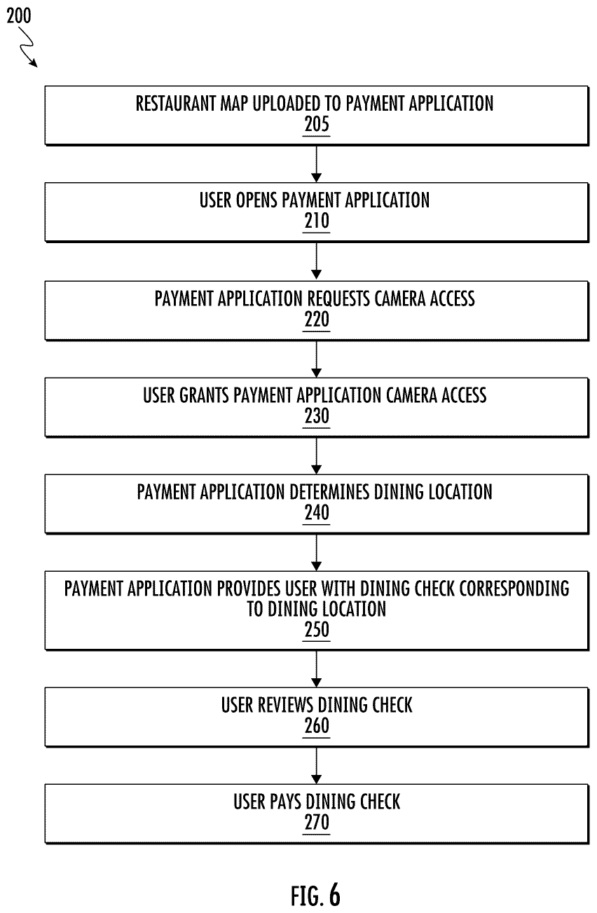

FIG. 6 is a flow diagram illustrating a method 200 in accordance with some embodiments of the present disclosure. A restaurant map including a plurality of dining locations is accessible to a payment application and may be, for example, uploaded to a payment application 205. A user may open and authenticate the payment application on their mobile device 210. The payment application may request access to the mobile camera on the user's mobile device 220. The user grants the payment application camera access 230. The payment application determines the dining table or dining location of the user 240 via indoor location technology, VPS, image information provided by the camera and/or computer vision. The payment application provides the user with a dining check associated with the determined dining location of the user 250. The user may review the dining check 260 prior to paying the dining check 270.

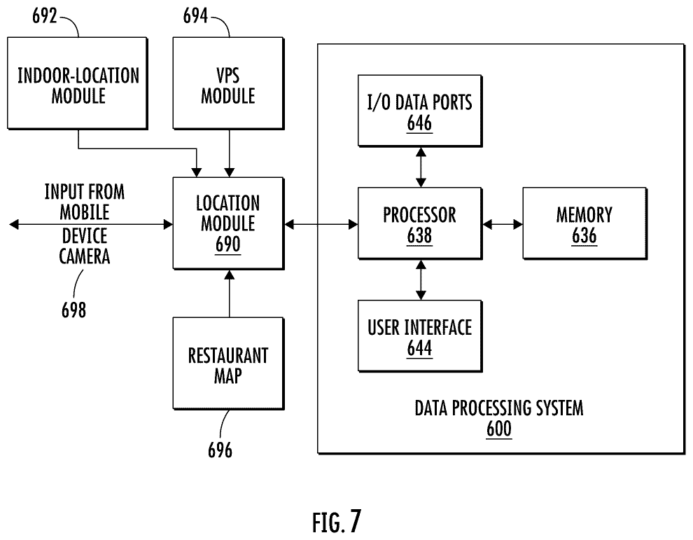

Referring now to FIG. 7, a data processor 600 is in communication with a location module 690 that receives inputs from the camera 698 and payment application including the restaurant map 696 will be discussed. It will be understood that the data processor may be included in any component of the system without departing from the scope of the present disclosure. For example, the data processor may be present in the indoor payment system 100 or may be centrally located.

As illustrated, FIG. 7 is a block diagram of an example of a data processing system 600 suitable for use in the systems in accordance with embodiments of the present disclosure. The data processing may take place in a mobile device, a server or a cloud server without departing from the scope of the present disclosure. The data processing system 600 includes a user interface 644 such as a keyboard, keypad, touchpad, voice activation circuit or the like, I/O data ports 646 and a memory 636 that communicates with a processor 638. The I/O data ports 646 can be used to transfer information between the data processing system 600 and another computer system or a network. These components may be conventional components, such as those used in many conventional data processing systems, which may be configured to operate as described herein. A location module 690 which may include indoor location module 692 and visual positioning module 694 processes inputs from the mobile device and payment application including camera 698 and restaurant map 696 and communicates with payment application 44 and data processing system 600.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Furthermore, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Furthermore, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

The present inventive concept provides a point-of-sale system including:
a seating map for a restaurant including a plurality of locations;
a mobile device having a camera and a payment application;
the camera providing image information used to determine a user's dining location from the plurality of locations on the seating map; and
the payment application providing a check corresponding to the user's dining location.

The present inventive concept further provides a location-aware system including:
a seating map including a plurality of locations; and
a mobile device, the mobile device configured to:
collect image information about a location of a user using a camera on the mobile device;
determine the location of a user from the plurality of locations on the seating map; and
provide payment information based on the location of the user from the payment application.

The present inventive concept also provides an indoor payment system including:
a restaurant map including a plurality of dining locations; and
a payment application on a mobile device, the mobile device including a display, and a camera wherein the payment application:
uses image information from the camera to select a user's dining location from the plurality of dining locations on the restaurant map;
displays a check corresponding to the user's dining location on the display; and provides a payment method for paying the check.

Additional features of present inventive concept may include any of the following, alone, or in combination:
indoor location-based technology or VPS or computer vision are used to determine the user's dining location from the plurality of locations on the seating map;
the payment application accesses the seating map and the image information to determine the user's dining location;
the seating map includes images of a dining area of the restaurant;
the payment application displays the check on the mobile device;
the user completes payment of the check via the mobile device;
beacons located in the restaurant, the beacons being used to determine the user's dining location from the plurality of locations on the seating map;
a network, the payment application being in communication with the network;
restaurant software, the payment application being in communication with the restaurant software to provide the check.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

While the foregoing is directed to aspects of the present disclosure, other and further embodiments of the disclosure may be devised without departing from the basic scope thereof, and the scope thereof is determined by the claims that follow.

What is claimed is:

1. A point-of-sale system comprising:
a processor; and
a memory storing instructions, wherein the processor is configured to perform operations comprising:
receiving map data, wherein the map data comprises a plurality of dining locations in a dining environment;
collecting image information captured by a mobile device of a user, wherein the image information comprises an image associated with a dining location of the user within the dining environment;
determining the dining location of the user based on the collected image information and the map data; and
transmitting, to the mobile device, payment information for the dining location of the user.

2. The point-of-sale system of claim 1, wherein the processor is further configured to:
receive, from the mobile device, a payment notification when a payment is made in response to the payment information.

3. The point-of-sale system of claim 1, wherein determining the dining location includes using indoor location-based technology or VPS or computer vision.

4. The point-of-sale system of claim 1, wherein each dining location is a dining table and the dining environment is a dining room.

5. The point-of-sale system of claim 4, wherein the map data includes images of the dining tables in the dining room.

6. The point-of-sale system of claim 1, wherein the map data includes images of the dining environment.

7. The point-of-sale system of claim 1, further comprising beacons located in the restaurant, the beacons being used to determine the dining location.

8. The point-of-sale system of claim 1, further comprising retrieving the payment information for the dining table from a restaurant management system.

9. The point-of-sale system of claim 1, further comprising generating an augmented overlay for the map data comprising the collected image information.

10. The point-of-sale system of claim 9, further comprising displaying the augmented overlay on a display.

11. The point-of-sale system of claim 9, further comprising displaying the augmented overlay and the map data on a display,

12. A method comprising:
receiving map data, wherein the map data includes a plurality of dining locations in a dining environment;
collecting image information captured by a mobile device of a user, wherein the image information includes an image associated with a dining location of the user within the dining environment;
determining the dining location of the user based on the collected image information and the map data; and
transmitting, to the mobile device, payment information for the dining location of the user.

13. The method of claim 12, further comprising:
receiving, from the mobile device, a payment notification when a payment is made in response to the payment information.

14. The method of claim 12, wherein determining the dining location includes using indoor location-based technology or VPS or computer vision.

15. The method of claim 12, wherein each dining location is a dining table and the dining environment is a dining room.

16. The method of claim 15, wherein the map data includes images of the dining tables in the dining room.

17. The method of claim 12, wherein the map data includes images of the dining environment.

18. The method of claim 12, further comprising beacons located in the restaurant, the beacons being used to determine the dining location.

19. The method of claim 12, further comprising retrieving the payment information for the dining table from a restaurant management system.

20. A non-transitory computer-readable medium storing computer executable instructions that when executed by one or more processors cause the one or more processors to:
receive map data, wherein the map data includes a plurality of dining locations in a dining environment;
collect image information captured by a mobile device of a user, wherein the image information includes an image associated with a dining location of the user within the dining environment;
determine the dining location of the user based on the collected image information and the map data; and
transmit, to the mobile device, payment information for the dining location of the user.
